(19) United States
(12) Patent Application Publication
(10) Pub. No.: US 2025/0344053 A1
(43) Pub. Date: Nov. 6, 2025

(54) WIRELESS NODE AND WIRELESS COMMUNICATION METHOD

(71) Applicant: PicoCELA Inc., Tokyo (JP)

(72) Inventors: Morihisa MOMONA, Tokyo (JP); Weiyuan PAN, Tokyo (JP); Yoichi OMORI, Tokyo (JP)

(21) Appl. No.: 18/708,347

(22) PCT Filed: Sep. 20, 2022
(86) PCT No.: PCT/JP2022/034984

§ 371 Date: Nov. 20, 2024

(30) Foreign Application Priority Data
Nov. 10, 2021 (JP) 2021-183346

(51) Int. Cl. H04W 8/24

(52) U.S. Cl. CPC H04W 8/24

(57) ABSTRACT

A wireless node that transmits, to a terminal, neighboring connection information for the terminal to wirelessly connect to a neighboring wireless node comprises: a reception unit that receives signals from the neighboring wireless node; and a control unit that generates neighboring connection information relevant to the basis of the signals. The reception unit receives settings change information pertaining to changes in wireless communication settings performed in the neighboring wireless node, from the neighboring wireless node. The control unit converts neighboring connection information relevant to the basis of the settings change information.

### TECHNICAL FIELD

The present disclosure relates to a wireless node and a wireless communication method.

### BACKGROUND ART

The IEEE 802.11k standard defines a roaming method for an STA (station). For example, it is assumed that the STA is being connected to a first AP (access point). The first AP transmits a channel list for one or a plurality of second APs in the neighborhood of the first AP in response to a request from the STA. The STA refers to the received channel list and roams from the first AP to a neighboring second AP.

Thus, the STA may perform channel scanning on a channel(s) in the channel list received from the first AP, for example, even without scanning every channel that may be used for wireless communication with APs, and can find a roaming target (second AP) early.

Note that, in the related art, a terminal roaming steering method for increasing a success rate of terminal roaming has been proposed (for example, see Patent Literature (hereinafter referred to as “PTL”) 1).

### CITATION LIST

### Patent Literature

### PTL 1

Japanese Patent Application Laid-Open No. 2021-175196

### SUMMARY OF INVENTION

### Technical Problem

Nonetheless, there is room for consideration for holding appropriate neighboring connection information, such as a channel list, in a wireless node.

### Solution to Problem

A wireless node according to an aspect is a wireless node that transmits neighboring connection information for a terminal to be connected to a neighboring wireless node wirelessly to the terminal. The wireless node includes: a reception unit that receives a signal from the neighboring wireless node; and a control unit that generates the neighboring connection information based on the signal. The reception unit receives setting change information relevant to a wireless communication setting change made in the neighboring wireless node from the neighboring wireless node, and the control unit changes the neighboring connection information based on the setting change information.

A wireless communication method according to an aspect is a wireless communication method of a wireless node that transmits neighboring connection information for a terminal to be connected to a neighboring wireless node wirelessly to the terminal. The wireless communication method includes: receiving a signal from the neighboring wireless node; generating the neighboring connection information based on the signal; receiving setting change information relevant to a wireless communication setting change made in the neighboring wireless node from the neighboring wireless node; and changing the neighboring connection information based on the setting change information.

### Advantageous Effects of Invention

According to a non-limiting aspect of the present disclosure, a wireless node is capable of holding appropriate neighboring connection information.

### BRIEF DESCRIPTION OF DRAWINGS

FIG. 1 illustrates an exemplary configuration of a wireless communication system according to an embodiment of the present disclosure;

FIG. 2 is a diagram provided for describing exemplary scanning operations of APs;

FIG. 3 is a diagram provided for describing exemplary notification registration request operations;

FIG. 4 illustrates exemplary neighboring connection information after a channel setting change in an AP;

FIG. 5 illustrates an exemplary hardware configuration of an AP;

FIG. 6 illustrates an exemplary functional configuration of an AP;

FIG. 7 is a sequence diagram illustrating exemplary scanning operations in the wireless communication system;

FIG. 8 is a sequence diagram illustrating exemplary setting change operations in the wireless communication system;

FIG. 9 is a sequence diagram illustrating exemplary neighboring connection information notification operations in the wireless communication system; and

FIG. 10 is a diagram provided for describing an example in which neighboring connection information in different networks is shared.

### DESCRIPTION OF EMBODIMENTS

Hereinafter, an embodiment will be described with reference to the drawings as appropriate. The same elements throughout the present specification in its entirety are denoted by the same reference signs unless otherwise noted. The matters described below together with the accompanying drawings are provided for describing an exemplary embodiment and not for indicating a sole embodiment. For example, in a case where an order of operations is indicated in the embodiment, the order of operations may be appropriately changed as long as there is no inconsistency as a whole operation.

In a case where a plurality of embodiments and/or variations is exemplified, some configurations, functions and/or operations in a given embodiment and/or variation may be included in another embodiment and/or variation or may be replaced with corresponding configurations, functions and/or operations in another embodiment and/or variation as long as there is no inconsistency.

Further, a detailed description more than necessary may be omitted in the embodiment. For example, a detailed description of a publicly-known or well-known technical matter may be omitted in order to facilitate the understanding of those skilled in the art by avoiding unnecessary redundancy of a description and/or an ambiguous technical matter or concept. Further, a duplicate description for a substantially identical configuration, function and/or operation may be omitted.

The accompanying drawings and the following description are provided in order to aid in the understanding of the embodiment, and are not intended to limit the subject matter described in the claims. Further, the terms used in the following description may also be appropriately replaced with other terms in order to aid those skilled in the art in their understanding.

### <Configuration of Wireless Communication System>

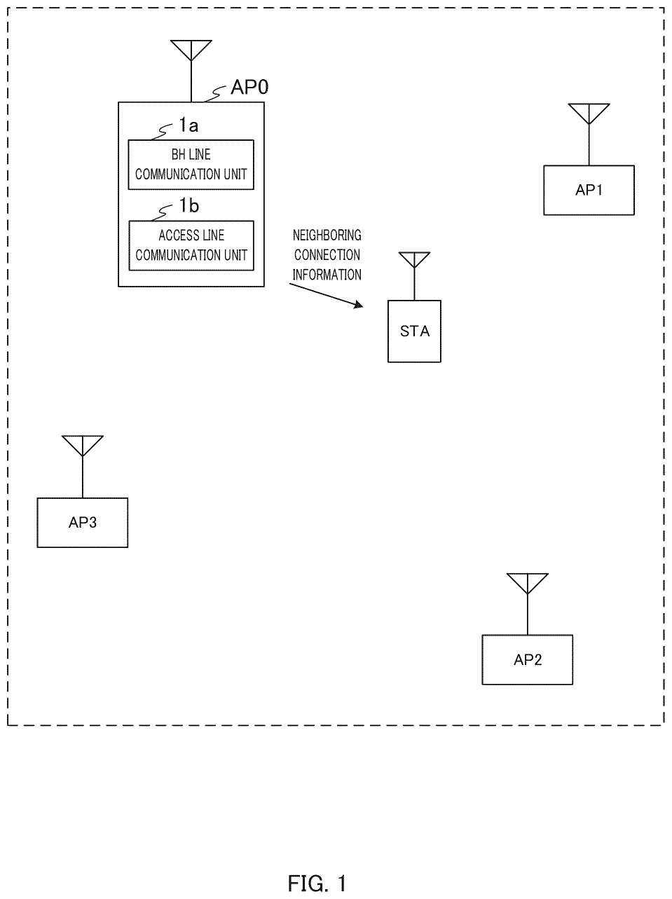

FIG. 1 illustrates an exemplary configuration of a wireless communication system according to an embodiment of the present disclosure. As illustrated in FIG. 1, the wireless communication system includes AP0 to AP3 and an STA. Hereinafter, AP0 to AP3 may also be referred to as the AP in a case where AP0 to AP3 are not distinguished.

AP0 includes BH (backhaul) line communication unit 1a and access line communication unit 1b. Although illustration is omitted, each of AP1 to AP3 also includes a BH line communication unit and an access line communication unit in the same manner as AP0.

BH line communication unit 1a communicates with AP1 to AP3. BH line communication unit 1a may communicate with AP1 to AP3 by using radio, or may communicate with AP1 to AP3 by using wires.

Access line communication unit 1b performs wireless communication with the STA. In a case where BH line communication unit 1a communicates with AP1 to AP3 by using radio, access line communication unit 1b communicates with the STA by using a channel or frequency band that differs from that used by BH line communication unit 1a. That is, the STA and the AP communicate with each other by using the access line, and APs communicate with each other by using the backhaul line.

The STA is a mobile communication apparatus. When the communication state between the STA and an AP which is being connected to the STA deteriorates due to, for example, movement of the STA, the STA executes roaming so as to perform wireless communication with an AP with which the STA has a good communication state.

The STA may execute roaming based on the IEEE 802.11k standard. For example, it is assumed that the STA is being connected to AP0 (performs wireless communication with AP0). The STA requests neighboring connection information from AP0 to which the STA is being connected. AP0 that has received the request for neighboring connection information transmits neighboring connection information to the STA.

As will be described later, the neighboring connection information to be transmitted by AP0 includes information for the STA to be connected to an AP in the neighborhood of AP0. In other words, the neighboring connection information to be transmitted by AP0 includes information for the STA to perform wireless communication with an AP in the neighborhood of AP0. For example, the neighboring connection information to be transmitted by AP0 includes information on a channel used by a neighboring AP of AP0. The neighboring connection information may be referred to as a channel list, roaming information, connection information, or the like. Further, the neighboring connection information may have a small data size so as to be transmitted/received with a simple protocol such as, for example, MQTT (message queueing telemetry transport).

The STA refers to the neighboring connection information received from AP0 and roams from AP0 to an AP in the neighborhood of AP0. For example, it is assumed that the neighboring connection information received from AP0 by the STA includes two pieces of channel information of information on a channel used by AP1 and information on a channel used by AP3. In this case, the STA scans the two channels included in the neighboring connection information, and is connected to, for example, an AP (AP1 or AP3) with which the STA has a good communication state.

As described above, the STA may perform channel scanning on the channels included in the neighboring connection information received from AP0 even without scanning every channel that may be used for wireless communication with the AP, and can find a roaming target early.

Note that, the AP may be referred to as a base station, a wireless node, or a node. The STA may be referred to as a terminal. The roaming may be referred to as a handover. The access line may be referred to as an access channel or an access network. The BH line may be referred to as a BH channel or a BH network. The BH may be read as relay. The neighborhood may be read as proximity or periphery. BH line communication unit 1a and access line communication unit 1b may be regarded as a communication unit including a transmission unit and a reception unit. The number of APs and the number of STAs in the wireless communication system are not limited to those in the example in FIG. 1.

### <Scanning Operations and Setting Change Notification Operations of AP>

The AP has scanning operations and setting change notification operations. In the scanning operations, the AP scans a channel(s) (for example, a channel(s) with the same ESSID (extended service set identifier) as the ESSID of the AP) on a network to which the AP belongs, and collects neighboring connection information.

Note that, as will be described later, the scanning operations of the AP include an operation to request (instruct) a neighboring AP to notify, in a case where (when) a setting change has been made in the neighboring AP, the AP of the changed content of the setting change. Hereinafter, this request may also be referred to as a notification registration request.

In the setting change notification operations, the AP notifies, in a case where a setting change such as a channel change has been made in the AP, a neighboring AP of the changed content of the setting change. The change may be read as an update.

Hereinafter, the scanning operations and setting change notification operations of the AP will be described in detail.

### <Scanning Operations of AP>

The AP may execute the channel scanning operations at the time of start, such as after power-on or after a reset operation. Further, the AP may also execute the channel scanning operations periodically. For example, the AP may execute the channel scanning operations in a time slot, such as late at night, when the number of STAs performing wireless communication decreases.

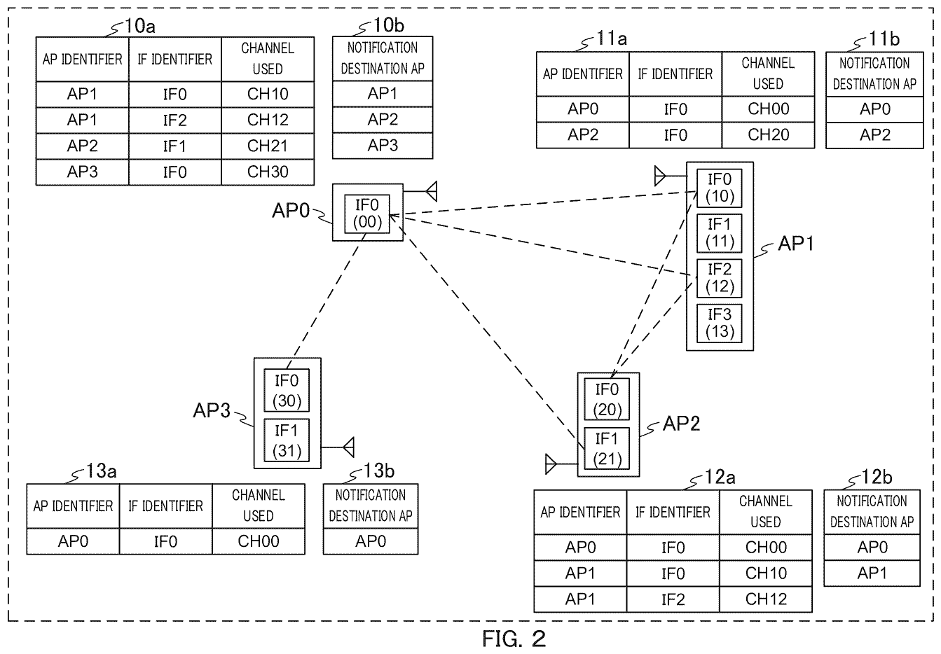

FIG. 2 is a diagram provided for describing exemplary scanning operations of the AP. FIG. 2 illustrates AP0 to AP3 illustrated in FIG. 1.

As illustrated in FIG. 2, AP0 includes IF0. AP1 includes IF0 to IF3. AP2 includes IF0 and IF1. AP3 includes IF0 and IF1. Hereinafter, IF0 to IF3 may also be referred to as the IF in a case where IF0 to IF3 are not distinguished.

The IF is a wireless interface for performing wireless communication. The IF may perform wireless communication in different frequency bands. For example, IF0 may perform wireless communication in the 2.4 GHz band, and IF1 may perform wireless communication in the 5 GHz band. The functions of the BH line communication unit and the access line communication unit in a case where wireless communication is performed, as described in FIG. 1, are implemented by the IF.

The IF performs wireless communication by using one of a plurality of channels. For example, IF0 of AP0 illustrated in FIG. 2 performs wireless communication by using CH00 among a plurality of channels. IF0 of AP1 illustrated in FIG. 2 performs wireless communication by using CH10 among the plurality of channels.

Different channels are set to a plurality of IFs included in one AP, respectively. For example, CH10 is set to IF0 of AP1, CH11 is set to IF1 of AP1, CH12 is set to IF2 of AP1, and CH13 is set to IF3 of AP1.

As illustrated in FIG. 2, AP0 stores neighboring connection information 10a and notification destination information 10b. AP1 stores neighboring connection information 11a and notification destination information 11b. AP2 stores neighboring connection information 12a and notification destination information 12b. AP3 stores neighboring connection information 13a and notification destination information 13b. Hereinafter, the pieces of neighboring connection information 10a to 13a may also be referred to as the neighboring connection information in a case where the pieces of neighboring connection information 10a to 13a are not distinguished, and the pieces of notification destination information 10b to 13b may also be referred to as the notification destination information in a case where the pieces of notification destination information 10b to 13b are not distinguished.

The neighboring connection information is information for the STA to be connected (roam) to a neighboring AP. The neighboring connection information includes an AP identifier(s), an IF identifier(s), and a channel(s) used. The AP identifier is an identifier assigned to AP0 to AP3 for identifying AP0 to AP3. The IF identifier is an identifier for identifying the IF included in the AP. The channel used indicates a channel used by the IF. Note that, the AP identifier may be a MAC (Media Access Control) address assigned to an AP, and the IF identifier may be a MAC addresses assigned to an IF.

The notification destination information is information indicating a notification destination(s) to which the changed content of a setting change made in the AP is notified. For example, in a case where a setting change such as a channel change has been made in AP1, AP1 refers to notification destination information 11b and notifies a neighboring AP(s) (AP0 and AP2 in the example of notification destination information 11b in FIG. 2) of the changed content of the setting change.

The neighboring connection information and notification destination information of the AP are collected by the scanning operations of the AP and are stored in a memory of the AP.

For example, AP0 scans a channel by using the access line and receives a beacon signal. A beacon signal includes, for example, information on the AP identifier and IF identifier of an AP that has transmitted the beacon signal. AP0 associates a channel when AP0 has received a beacon signal with information on the AP identifier and IF identifier included in the beacon signal, and stores neighboring connection information 10a in the memory.

More specifically, it is assumed that AP0 has received a beacon signal in the channel “CH10”, and it is assumed that the beacon signal in the channel “CH10” includes the AP identifier “AP1” and the IF identifier “IF0”.

Further, it is assumed that AP0 has received a beacon signal in the channel “CH12”, and it is assumed that the beacon signal in the channel “CH12” includes the AP identifier “AP1” and the IF identifier “IF2”.

Further, it is assumed that AP0 has received a beacon signal in the channel “CH21”, and it is assumed that the beacon signal in the channel “CH21” includes the AP identifier “AP2” and the IF identifier “IF1”.

Further, it is assumed that AP0 has received a beacon signal in the channel “CH30”, and it is assumed that the beacon signal in the channel “CH30” includes the AP identifier “AP3” and the IF identifier “IF0”.

In this case, neighboring connection information 10a illustrated in FIG. 2 is stored in the memory of AP0. As described above, AP0 collects neighboring connection information on an AP (for example, an AP that has been able to receive a beacon signal) in the neighborhood of AP0 by the channel scanning operations, and stores the collected neighboring connection information in the memory.

AP1 to AP3 also perform channel scanning in the same manner as AP0, and collect neighboring connection information 11a to 13a. AP1 to AP3 store neighboring connection information 11a to 13a, which AP1 to AP3 have collected, in the memory.

As described above, the AP collects, in the scanning operations, the neighboring connection information for the STA to be connected to a neighboring AP, and stores the collected neighboring connection information in the memory.

Note that, a neighbor of the AP may be regarded as a neighbor in relation to a distance in terms of radio waves. For example, even when AP0 and AP3 are neighbors in terms of positions (arrangement), AP0 and AP3 may not be regarded as neighbors unless radio waves are reachable therebetween (for example, unless a beacon signal can be received therebetween due to a shielding object or the like).

### <Notification Registration Request Operations of AP>

As described above, in the scanning operations, the AP performs a notification registration request to a neighboring AP. That is, in a case where a setting change such as a channel change has been made in a neighboring AP, the AP requests the neighboring AP to notify the changed content of the setting change. For a notification registration request, the BH line is used.

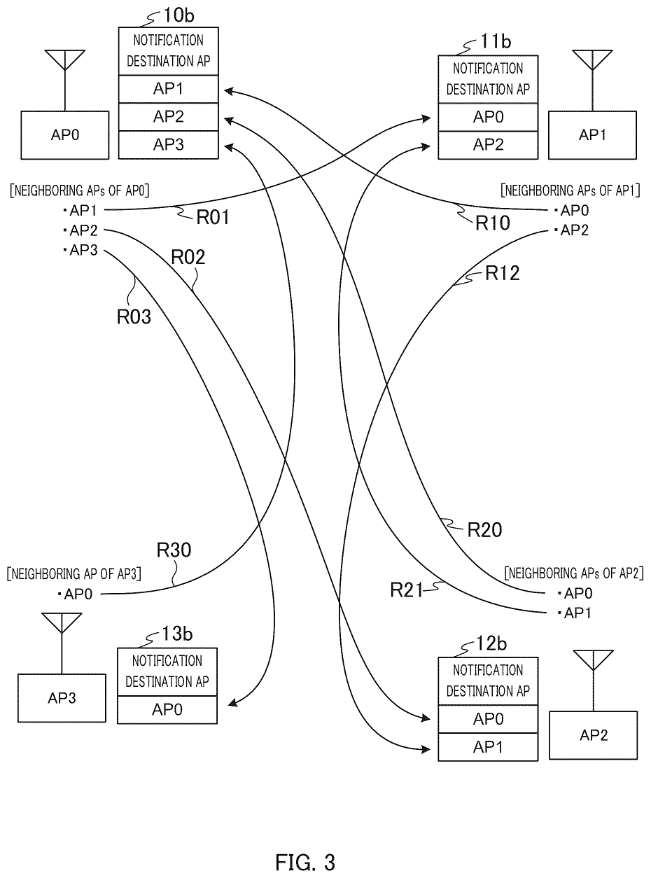

FIG. 3 is a diagram provided for describing exemplary notification registration request operations. In FIG. 3, constituent elements that are the same as those in FIG. 2 are denoted by the same reference signs.

For example, as described in the specific example in FIG. 2 above, AP0 receives beacon signals of AP1 to AP3. Accordingly, neighboring APs of AP0 are AP1 to AP3. In this case, AP0 transmits notification registration requests R01, R02 and R03 to AP1 to AP3 in the neighborhood of AP0 by using the BH line.

AP1 to AP3 that have received the notification registration requests of AP0 store, as notification destination information, the AP identifier of AP0 that has transmitted the notification registration requests, in the memory.

For example, AP1 that has received notification registration request R01 of AP0 stores the AP identifier “AP0” of AP0, which has transmitted the notification registration request, in the memory as illustrated in notification destination information 11b in FIG. 3. AP2 that has received notification registration request R02 of AP0 stores the AP identifier “AP0” of AP0, which has transmitted the notification registration request, in the memory as illustrated in notification destination information 12b in FIG. 3. AP3 that has received notification registration request R03 of AP0 stores the AP identifier “AP0” of AP0, which has transmitted the notification registration request, in the memory as illustrated in notification destination information 13b in FIG. 3.

In the same manner, AP1 to AP3 also a transmit notification registration request(s) to a neighboring AP(s). For example, AP1 transmits notification registration requests R10 and R12 to AP0 and AP2 in the neighborhood of AP1. AP0 that has received notification registration request R10 stores the AP identifier “AP1” of AP1, which has transmitted notification registration request R10, as illustrated in notification destination information 10b in FIG. 3. AP2 that has received notification registration request R12 stores the AP identifier “AP1” of AP1, which has transmitted notification registration request R12, as illustrated in notification destination information 12b in FIG. 3.

Further, for example, AP2 transmits notification registration requests R20 and R21 to AP0 and AP1 in the neighborhood of AP2. AP0 that has received notification registration request R20 stores the AP identifier “AP2” of AP2, which has transmitted notification registration request R20, as illustrated in notification destination information 10b in FIG. 3. AP1 that has received notification registration request R21 stores the AP identifier “AP2” of AP2, which has transmitted notification registration request R21, as illustrated in notification destination information 11b in FIG. 3.

Further, for example, AP3 transmits notification registration request R30 to AP0 in the neighborhood of AP3. AP0 that has received notification registration request R30 stores the AP identifier “AP3” of AP3, which has transmitted notification registration request R30, as illustrated in notification destination information 10b in FIG. 3.

As described above, the AP transmits a notification registration request(s) to a neighboring AP(s) in the scanning operations. A neighboring AP that has received a notification registration request stores, in the memory, notification destination information indicating a notification destination(s) to which the changed content in a case where a setting change has been made in the neighboring AP is notified.

### <Setting Change Notification Operations of AP>

The AP may execute the setting change notification operations, for example, during a normal operation to perform wireless communication of user data with the STA. For example, in a case where a setting change such as a channel change has been made in the AP by an operator manually or by remote control (for example, an operator terminal connected via the BH line), the AP may change the channel for the access line, with which the AP performs wireless communication with the STA, and execute the setting change notification operations.

In a case where a setting change has been made in the AP, the AP notifies a neighboring AP(s) of the changed content of the setting change according to a notification destination(s) AP(s) (an AP identifier(s)) in notification destination information stored in the memory. The neighboring AP(s) change(s) the neighboring connection information based on the notified changed content. For a changed content notification, the BH line is used.

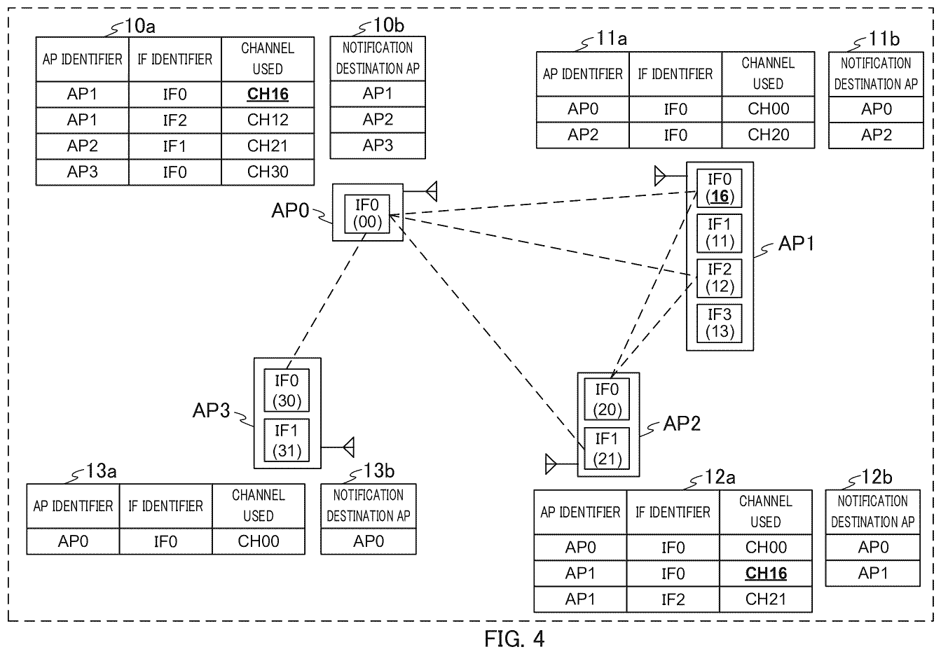

FIG. 4 illustrates exemplary neighboring connection information after a channel setting change in AP1. In FIG. 4, constituent elements that are the same as those in FIG. 2 are denoted by the same reference signs.

As illustrated in FIG. 4, it is assumed that the channel in IF0 of AP1 is changed from “10” (see FIG. 2) to “16”. Here, the AP identifiers “AP0” and “AP2” are stored in notification destination information 11b of AP1 as illustrated in FIG. 4. Accordingly, AP1 notifies AP0 and AP2 of, for example, the AP identifier “AP1” of AP1 in which the setting change has been made, information “IF0” on the IF in which the channel change has been made, and information “16” on the channel after the channel change.

AP0 that has been notified of the changed content changes neighboring connection information 10a based on the notified changed content (setting change information). For example, AP0 changes the channel used, which corresponds to IF0 of AP1 in neighboring connection information 10a, to “CH16” as illustrated in FIG. 4.

In addition, AP2 that has been notified of the changed content changes neighboring connection information 12a based on the notified changed content. For example, AP2 changes the channel used, which corresponds to IF0 of AP1 in neighboring connection information 12a, to “CH16” as illustrated in FIG. 4.

Note that, although exemplary changes in neighboring connection information in neighboring APs in a case where a setting change has been made in AP1 have been described in FIG. 4, the same operations are also performed in other AP0, AP2, and AP3. For example, it is assumed that a setting change has been made in AP3. In this case, AP0 is notified of the changed content in AP3 (see notification destination information 13b in FIG. 4). AP0 changes connection information on AP3 in neighboring connection information 10a.

As described above, in a case where a setting change has been made in a neighboring AP, the neighboring AP transmits the changed content of the setting change to an AP that has made a notification registration request. Accordingly, for example, the AP does not need to frequently execute channel scanning by using the access line in order to monitor that a setting change such as a channel change is made in a neighboring AP. In addition, since the AP does not need to frequently execute channel scanning by using the access line, it is possible to suppress a reduction in opportunities for communication with the STA.

Further, in a case where a setting change has been made in a neighboring AP, the AP can immediately update the neighboring connection information based on the changed content transmitted from the neighboring AP. Accordingly, in a case where there is a request for neighboring connection information from the STA, the AP can notify the STA of the latest neighboring connection information. Further, since the STA can perform roaming based on the latest neighboring connection information, it is possible to reduce failures of roaming to a neighboring AP.

### <Hardware Configuration of AP>

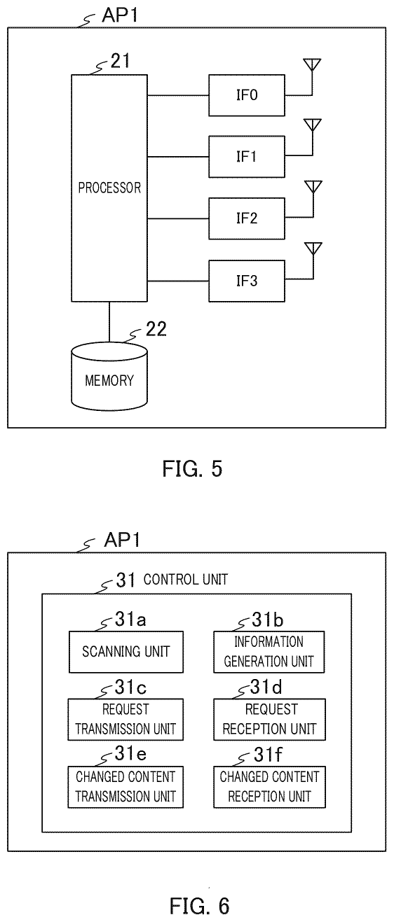

FIG. 5 illustrates an exemplary hardware configuration of AP1. As illustrated in FIG. 5, AP1 includes processor 21, memory 22, and IF0 to IF3. Note that, the number of IFs is not limited to that in the example in FIG. 5.

Processor 21 controls AP1 in its entirety. Processor 21 may be, for example, a central processing unit (CPU) or a digital signal processor (DSP).

Memory 22 stores operating system (OS) programs and application programs that processor 21 executes. Memory 22 also stores various types of data required for processing by processor 21. Memory 22 may be, for example, a read only memory (ROM), a random access memory (RAM), a flash memory, a solid state drive (SSD), and/or a hard disk drive (HDD).

IF0 to IF3 are wireless interfaces for performing wireless communication. For IF0 to IF3, channels for wireless communication are set and changed based on the control of processor 21. IF0 to IF3 perform wireless communication with the STA via the access line and perform wireless communication with a neighboring AP via the BH line.

Note that, AP1 may communicate with a neighboring AP via the BH line based on the wire. In this case, AP1 may include a wired interface connected to processor 21. Processor 21 may communicate with a neighboring AP via the wired interface. IF0 to IF3 may be referred to as a communication unit. The IF may be referred to as an IF circuit. The IF may include a circuit for access line processing and a circuit for BH line processing.

AP0, AP2, and AP3 also have the same hardware configuration as AP1, and descriptions thereof will be omitted.

### <Functional Configuration of AP>

FIG. 6 illustrates an exemplary functional configuration of AP1. As illustrated in FIG. 6, AP1 includes control unit 31. The function of control unit 31 may be implemented by, for example, processor 21 illustrated in FIG. 5. Control unit 31 includes scanning unit 31a, information generation unit 31b, request transmission unit 31c, request reception unit 31d, changed content transmission unit 31e, and changed content reception unit 31f.

Scanning unit 31a receives a beacon signal while changing the channels in IF0 to IF3. Scanning unit 31a performs, for example, the scanning operations at the time of start of AP1 or periodically.

Information generation unit 31b generates neighboring connection information based on a beacon signal received by scanning unit 31a. Information generation unit 31b stores the generated neighboring connection information in memory 22. That is, information generation unit 31b stores neighboring connection information on a neighboring AP of AP1 in memory 22.

Request transmission unit 31c transmits a notification registration request to a neighboring AP of AP1. For example, request transmission unit 31c determines, as a neighboring AP, a transmission source AP of a beacon signal received by scanning unit 31a, and transmits a notification registration request to the determined neighboring AP.

Request reception unit 31d receives a notification registration request. Request reception unit 31d stores, as notification destination information, the AP identifier of a neighboring AP which has transmitted the notification registration request, in memory 22. That is, request reception unit 31d stores, in a case where a setting change to AP1 has been made, notification destination information for transmitting the changed content of the setting change to a neighboring AP in memory 22.

In a case where a setting change to AP1 has been made, changed content transmission unit 31e refers to the notification destination information stored in memory 22, and specifies a neighboring AP(s) to which changed content transmission unit 31e transmits the changed content of the setting change. Changed content transmission unit 31e transmits the changed content to the specified neighboring AP(s).

Changed content reception unit 31f receives the changed content transmitted from a neighboring AP in which a setting change has been made. Changed content transmission unit 31e changes, based on the received changed content, the neighboring connection information corresponding to the neighboring AP that has transmitted the changed content.

AP0, AP2, and AP3 also have the same functional configuration as AP1, and descriptions thereof will be omitted.

### <Scanning Operations in Wireless Communication System>

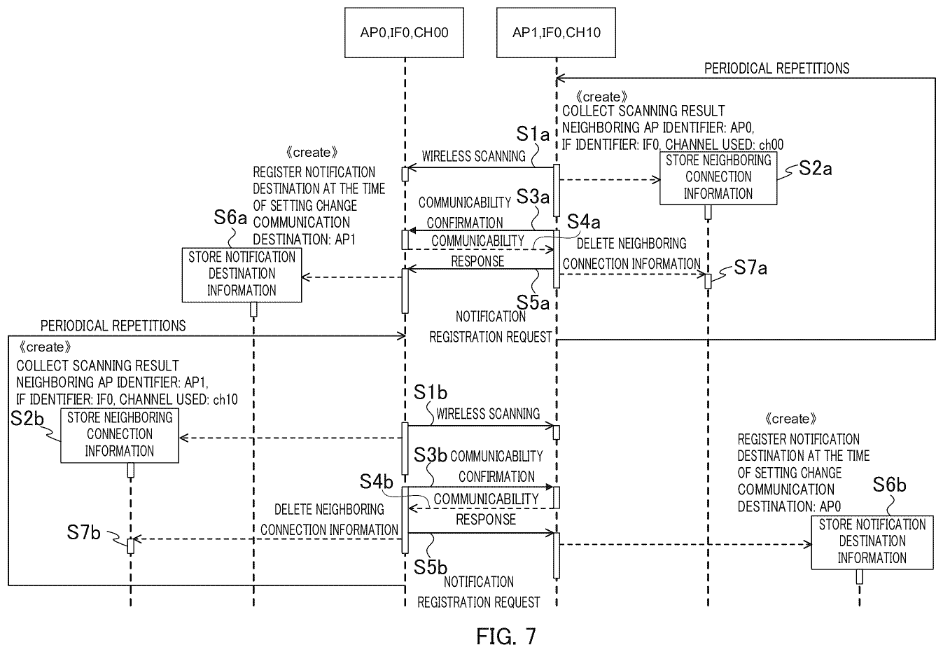

FIG. 7 is a sequence diagram illustrating exemplary scanning operations in the wireless communication system. In FIG. 7, exemplary scanning operations in AP0 and AP1 will be described. AP0 and AP1 may execute the scanning operations illustrated in FIG. 7 periodically, for example, at the time of start or in a time slot such as late at night.

AP1 performs channel scanning (wireless scanning) (Sla). Here, AP1 scans the channel “CH00” in IF0 of AP0.

When AP1 scans the channel “CH00” in IF0 of AP0, AP1 generates neighboring connection information on AP0 and stores the generated neighboring connection information in the memory (S2a). For example, AP1 generates neighboring connection information including the AP identifier “AP0”, the IF identifier “IF0”, and the channel used “CH00”, and stores the generated neighboring connection information in the memory (for example, see neighboring connection information 11a in FIG. 2).

After storing the neighboring connection information on AP0 in the memory, AP1 performs communicability confirmation to AP0 (S3a). AP1 performs the communicability confirmation to AP0 via the BH line. That is, AP1 confirms whether AP1 can communicate with AP0, for which AP1 has performed the wireless scanning, via the BH line. Here, AP1 receives a communicability response from AP0 (S4a). That is, it is assumed that AP1 is being connected to AP0 via the BH line.

In a case where AP1 has received the communicability response from AP0, AP1 transmits a notification registration request to AP0 (S5a). That is, in a case where a setting change such as a channel change has been made in AP0, AP1 requests AP0 to notify AP1 of the changed content of the setting change.

AP0 generates notification destination information in response to the notification registration request from AP1, and stores the generated notification destination information in the memory (S6a). For example, AP0 stores, in the memory, notification destination information including the AP identifier “AP1” of AP1 that has transmitted the notification registration request (for example, see notification destination information 10b in FIG. 2). Thus, in a case where a setting change has been made in AP0, AP0 can notify AP1 of the changed content by referring to the notification destination information stored in the memory.

In a case where AP1 has not received the communicability response in S4a, on the other hand, AP1 deletes the neighboring connection information on AP0 (the neighboring connection information on AP0 stored in the memory in S2a) from the memory (S7a). That is, in a case where AP1 is not being connected to AP0 via the BH line, AP1 deletes the neighboring connection information on AP0 from the memory. In other words, in a case where AP1 is not being connected to AP0 via the BH line, AP1 cannot transmit a notification registration request to AP0 and cannot receive information on a setting change to AP0, either, and thus, AP1 deletes the neighboring connection information on AP0 from the memory.

AP0 performs wireless scanning (S1b). Here, AP0 scans the channel “CH10” in IF0 of AP1.

When AP0 scans the channel “CH10” in IF0 of AP1, AP0 generates neighboring connection information on AP1 and stores the generated neighboring connection information in the memory (S2b). For example, AP0 generates neighboring connection information including the AP identifier “AP1”, the IF identifier “IF0”, and the channel used “CH10”, and stores the generated neighboring connection information in the memory (for example, see neighboring connection information 10a in FIG. 2).

After storing the neighboring connection information on AP1 in the memory, AP0 performs communicability confirmation to AP1 (S3b). AP0 performs the communicability confirmation to AP1 via the BH line. That is, AP0 confirms whether AP0 can communicate with AP1, for which AP0 has performed the wireless scanning, via the BH line. Here, AP0 receives a communicability response from AP1 (S4b). That is, it is assumed that AP0 is being connected to AP1 via the BH line.

In a case where AP0 has received the communicability response from AP1, AP0 transmits a notification registration request to AP1 (S5b). That is, in a case where a setting change such as a channel change has been made in AP1, AP0 requests AP1 to notify AP0 of the changed content of the setting change.

AP1 generates notification destination information in response to the notification registration request from AP0, and stores the generated notification destination information in the memory (S6b). For example, AP1 stores, in the memory, notification destination information including the AP identifier “AP0” of AP0 that has transmitted the notification registration request (for example, see notification destination information 11b in FIG. 2). Thus, in a case where a setting change has been made in AP1, AP1 can notify AP0 of the changed content by referring to the notification destination information stored in the memory.

In a case where AP0 has not received the communicability response in S4b, on the other hand, AP0 deletes the neighboring connection information on AP1 (the neighboring connection information on AP1 stored in the memory in S2b) from the memory (S7b). That is, in a case where AP0 is not being connected to AP1 via the BH line, AP0 deletes the neighboring connection information on AP1 from the memory. In other words, in a case where AP0 is not being connected to AP1 via the BH line, AP0 cannot transmit a notification registration request to AP1 and cannot receive information on a setting change to AP1, either, and thus, AP0 deletes the neighboring connection information on AP1 from the memory.

With the operations described above, AP0 and AP1 can transmit neighboring connection information to the STA in a case where AP0 and AP1 receive a request to transmit neighboring connection information from the STA. Further, in a case where a setting change has been made in AP0 or AP1, AP0 or AP1 can notify a neighboring AP of the changed content of the setting change by referring to notification destination information stored in the memory.

Further, AP0 and AP1 autonomously generate neighboring connection information and store the generated neighboring connection information in the memory. Thus, AP0 and AP1 can prevent, for example, an error in manually inputting neighboring connection information. In addition, AP0 and AP1 can save labor for manually inputting neighboring connection information.

Further, AP0 and AP1 can reduce the network load due to scanning by adjustment of a time slot during which the scanning is executed.

### <Setting Change Operations in Wireless Communication System>

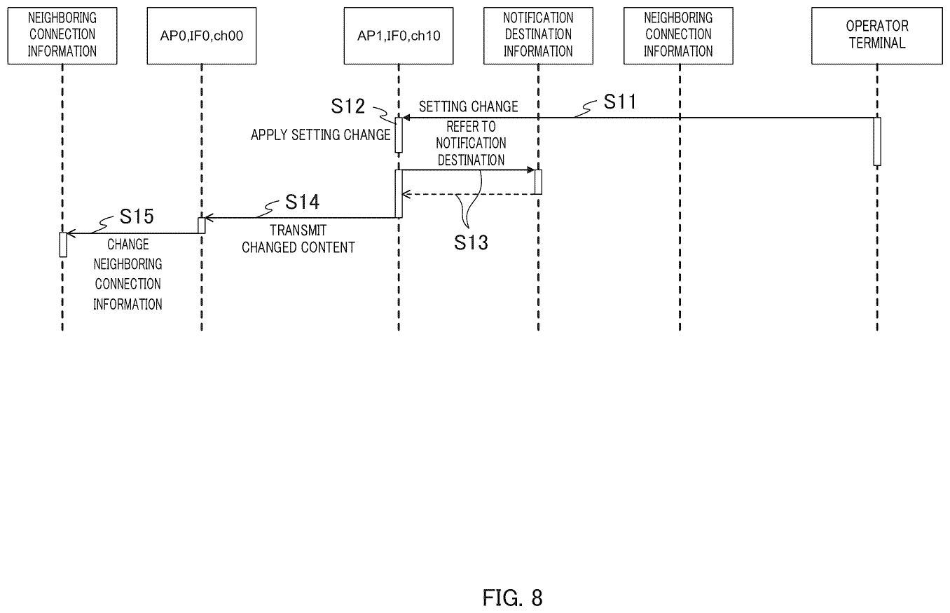

FIG. 8 is a sequence diagram illustrating exemplary setting change operations in the wireless communication system. FIG. 8 describes exemplary setting change operations in AP0 and AP1. FIG. 8 illustrates an operator terminal connected to the BH line. For example, in a case where a setting change has been made by an operator during a normal operation to perform wireless communication of user data with the STA, AP0 and AP1 may execute the setting change operations illustrated in FIG. 8.

The operator terminal performs a setting change for AP1 (S11).

AP1 performs a setting change to AP1 in response to the setting change by the operator terminal (S12).

After performing the setting change, AP1 refers to notification destination information stored in the memory and identifies an AP(s) to which AP1 notifies (transmits) the changed content of the setting change (S13). Here, AP1 identifies AP0.

AP1 transmits the changed content of the setting change to AP0, which AP1 has specified, by using the BH line (S14).

AP0 changes, based on the changed content transmitted from AP1, neighboring connection information on AP1 stored in the memory (S15).

With the operations described above, AP0 does not need to frequently execute channel scanning by using the access line in order to monitor that a setting change such as a channel change is made in AP1 in the neighborhood of AP0. In addition, since AP0 does not need to frequently execute channel scanning by using the access line, it is possible to suppress a reduction in opportunities for communication with the STA.

Further, AP1 transmits the changed content of a setting change to AP0 by using the BH line. Thus, it is possible to suppress a decrease in the communication speed of the access line.

Further, in a case where a setting change has been made in AP1 in the neighborhood of AP0, AP0 can immediately update the neighboring connection information based on the changed content transmitted from AP1 in the neighborhood of AP0. Accordingly, in a case where there is a request for neighboring connection information from the STA, the AP0 can notify the STA of the latest neighboring connection information.

Further, AP0 autonomously changes neighboring connection information. Thus, AP0 can prevent, for example, an error in manually inputting neighboring connection information. In addition, AP0 can save labor for manually inputting neighboring connection information.

### <Neighboring Connection Information Notification Operations in Wireless Communication System>

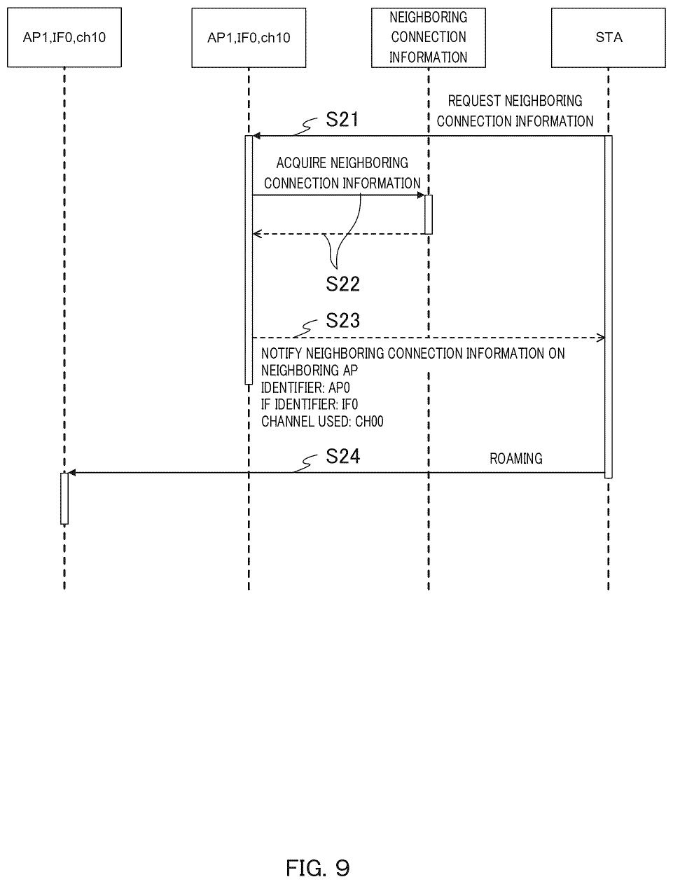

FIG. 9 is a sequence diagram illustrating exemplary neighboring connection information notification operations in the wireless communication system. In FIG. 9, exemplary neighboring connection information operations in AP1, AP0, and the STA will be described.

The STA requests neighboring connection information from AP1 (S21). For example, in a case where the signal reception quality in AP1 is equal to or less than a threshold, the STA requests neighboring connection information from AP1. Note that, the signal reception quality may be, for example, the received signal strength indicator (RSSI), the signal-to-interference plus noise power ratio (SINR), or the signal-noise ratio (SNR).

AP1 acquires, in response to the request for neighboring connection information from the STA, neighboring connection information stored in the memory (S22). That is, AP1 acquires, from the memory, information for the STA to be connected to a neighboring AP (AP0) of AP1.

AP1 transmits the acquired neighboring connection information to the STA (S23).

The STA roams to a neighboring AP (here, AP0) of AP1 based on the received neighboring connection information (S24).

Note that, the neighboring connection information may include neighboring connection information on a plurality of neighboring APs. In a case where neighboring connection information received by the STA includes connection information on a plurality of neighboring APs, the STA may roam to a predetermined neighboring AP according to a predetermined algorithm.

With the operations described above, the STA can roam from AP1, to which the STA is currently being connected, to AP0 in the neighborhood of AP1.

In addition, as described in FIG. 8, even in a case where a setting change has been made in AP0 in the neighborhood of AP1, AP1 immediately stores the latest neighboring connection information after the setting change in the memory. Accordingly, since the STA can perform roaming based on the latest neighboring connection information, it is possible to reduce failures in roaming to a neighboring AP in which a setting change has been made.

Note that, the order of the processing in S21 and the processing in S22 may be interchanged.

### Summary of Embodiment

As described above, the AP transmits neighboring connection information for the STA to be connected to a neighboring AP in response to a request from the STA. The IF of the AP receives (scans) a signal, such as a beacon signal, of the neighboring AP. Control unit 31 of the AP generates neighboring connection information based on the signal received by the IF. Then, the IF of the AP receives setting change information (changed content) on a wireless communication setting change made in the neighboring AP from the neighboring AP, and control unit 31 of the AP changes the neighboring connection information based on the setting change information received from the neighboring AP.

That is, the AP generates the neighboring connection information based on the signal of the neighboring AP, and changes the generated neighboring connection information based on the setting change information transmitted from the neighboring AP. Thus, the AP can hold appropriate neighboring connection information. For example, it is assumed that a channel change has been made in a neighboring AP. In this case, the AP receives channel information after the channel change from the neighboring AP. Thus, the AP can change the channel information in the generated neighboring connection information and can hold appropriate neighboring connection information.

### <Variation 1>

The AP may decide neighboring connection information to be transmitted to the STA based on the signal reception quality in a neighboring AP.

For example, the AP stores, together with neighboring connection information to be stored in the memory, the reception quality of a beacon signal received from a neighboring AP. The AP transmits neighboring connection information corresponding to reception quality exceeding a threshold to the STA. That is, the neighboring connection information includes the signal reception quality in the neighboring AP, and the AP transmits neighboring connection information corresponding to reception quality exceeding the threshold to the STA. Thus, the STA can roam to a neighboring AP having a good signal quality.

Note that, the AP may store neighboring connection information on reception quality exceeding the threshold in the memory. The AP may transmit the neighboring connection information on reception quality exceeding the threshold, which is stored in the memory, to the STA. Thus, the STA can also roam to a neighboring AP having a good signal quality.

### <Variation 2>

The maximum number of pieces of neighboring connection information to be transmitted by the AP to the STA may be determined. For example, the AP may transmit up to six pieces of neighboring connection information to the STA.

The maximum number of pieces of neighboring connection information to be transmitted to the STA may vary for each AP. For example, the maximum number of pieces of neighboring connection information may vary based on the positional distance to a neighboring AP. For example, in a case where the distance to a neighboring AP is long, the maximum number of pieces of neighboring connection information to be transmitted to the STA may be decreased or increased.

In a case where the number of pieces of neighboring connection information to be notified to the STA is large, it takes time for the STA to perform processing of deciding a roaming target, but the processing of deciding a roaming target by the STA is limited by determining the maximum number of pieces of neighboring connection information to be transmitted from the AP to the STA. Thus, the STA can reduce the time for the processing of deciding a roaming target.

### <Variation 3>

When the AP collects neighboring connection information on a neighboring AP in the scanning operations, the AP may decide the neighboring connection information on the neighboring AP to be collected based on the connection degree of the neighboring AP in the BH line. For example, the AP may collect neighboring connection information on a neighboring AP with a connection degree equal to or less than a threshold.

It is supposed that the positional distance between the AP and a neighboring AP is smaller as the connection degree in the BH line is lower. Then, it is supposed that as the distance between the AP and the neighboring AP is smaller, a decrease in the signal quality when the STA roams from the AP to the neighboring AP is suppressed. That is, it is supposed that when the AP collects neighboring connection information on a neighboring AP with a connection degree equal to or less than the threshold, a decrease in the communication quality when the STA roams from the AP to the neighboring AP is suppressed. Thus, the STA can perform roaming while suppressing a decrease in the communication quality.

### <Variation 4>

The scanning operations and/or setting change notification operations of the AP may be executed by dedicated hardware. Thus, the AP can accelerate the scanning operations.

### <Variation 5>

The AP may share neighboring connection information in different networks. For example, the AP may share neighboring connection information on neighboring APs that belong to networks with different network names.

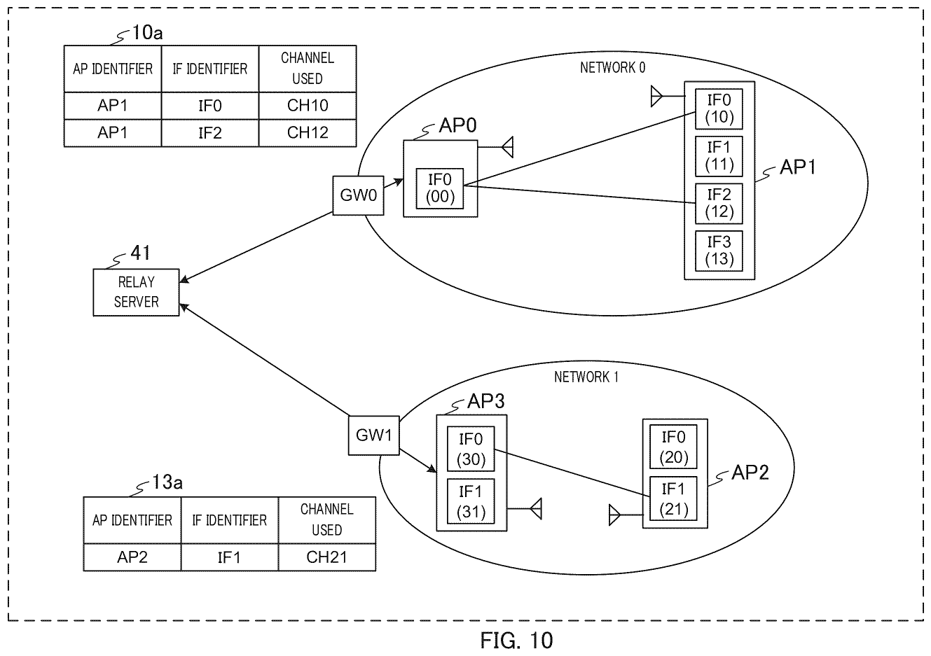

FIG. 10 is a diagram provided for describing an example in which neighboring connection information in different networks is shared. In FIG. 10, constituent elements that are the same as those in FIG. 2 are denoted by the same reference signs. FIG. 10 illustrates neighboring connection information 10a, which is stored in the memory of AP0, and neighboring connection information 13a, which is stored in the memory of AP3.

In FIG. 10, AP0 and AP1 belong to a network with the network name “0”. AP3 and AP4 belong to a network with the network name “0”. AP0 is connected to GW (gateway) 0. AP3 is connected to GW1. GW0 and GW1 are connected via relay server 41.

In FIG. 10, it is assumed that AP1 and AP3 are neighbors in terms of radio waves. That is, it is assumed that AP3 is a neighboring AP of AP1.

In this case, AP0 having neighboring connection information 10a on AP1 may transmit neighboring connection information 10a on AP1 to AP3 (AP3 is a neighboring AP of AP1), which belongs to the other network, via relay server 41. Then, in a case where there is a notification request for neighboring connection information from the STA, AP3 may transmit neighboring connection information 13a belonging to the same network and neighboring connection information 10a on AP1 belonging to the other network to the STA. Thus, the STA can perform roaming between different networks.

In addition, in FIG. 10, it is assumed that AP0 and AP2 are neighbors in terms of radio waves. That is, AP2 is a neighboring AP of AP0.

In this case, AP3 having neighboring connection information 13a on AP2 may transmit neighboring connection information 13a on AP2 to AP0 (AP0 is a neighboring AP of AP2), which belongs to the other network, via relay server 41. Then, in a case where there is a notification request for neighboring connection information from the STA, AP0 may transmit neighboring connection information 10a belonging to the same network and neighboring connection information 10a on AP2 belonging to the other network to the STA. Thus, the STA can perform roaming between different networks.

The disclosure of Japanese Patent Application No. 2021-183346, filed on Nov. 10, 2021, including the specification, drawings and abstract, is incorporated herein by reference in its entirety.

### INDUSTRIAL APPLICABILITY

The present disclosure is useful for a wireless communication system such as a wireless LAN (local area network).

### REFERENCE SIGNS LIST

AP0 to AP3 Access point
STA Station
GW0, GW1 Gateway
1a BH line communication unit
1b Access line communication unit
10a to 13a Neighboring connection information
10b to 13b Notification destination information
21 Processor
22 Memory
31 Control unit
31a Scanning unit
31b Information generation unit
31c Request transmission unit
31d Request reception unit
31e Changed content transmission unit
31f Changed content reception unit
41 Relay server

1. A wireless node that transmits neighboring connection information to a terminal, the neighboring connection information being information for the terminal to be connected to a neighboring wireless node wirelessly, the wireless node comprising:
a reception unit that receives a signal from the neighboring wireless node; and
a control unit that generates the neighboring connection information based on the signal, wherein:
the reception unit receives setting change information relevant to a wireless communication setting change from the neighboring wireless node, made in the neighboring wireless node, and
the control unit changes the neighboring connection information based on the setting change information.

2. The wireless node according to claim 1, wherein
the control unit makes a request to the neighboring wireless node to transmit the setting change information when the wireless communication setting change has been made.

3. The wireless node according to claim 2, wherein:
the control unit generates the neighboring connection information when the wireless node is powered on or periodically, and
the control unit executes the request at times when the neighboring connection information is generated periodically.

4. The wireless node according to any claim 1, wherein
when a wireless communication setting change has been made in the wireless node, the control unit transmits the setting change information to the neighboring wireless node, the setting change information being information for changing the neighboring connection information relevant to the wireless node.

5. The wireless node according to claim 1, wherein:
the reception unit receives the signal by using a first line, and
the reception unit receives the setting change information by using a second line different from the first line.

6. The wireless node according to claim 5, wherein:
the first line is an access line for communicating with the terminal, and
the second line is a backhaul line for communicating with the neighboring wireless node.

7. A wireless communication method of a wireless node, the wireless node transmitting neighboring connection information to a terminal, the neighboring connection information being information for the terminal to be connected to a neighboring wireless node wirelessly, the wireless communication method comprising:
receiving a signal from the neighboring wireless node;
generating the neighboring connection information based on the signal;
receiving setting change information relevant to a wireless communication setting change from the neighboring wireless node, made in the neighboring wireless node; and
changing the neighboring connection information based on the setting change information.
